(19) United States
(12) Patent Application Publication
(10) Pub. No.: US 2010/0064737 A1
(43) Pub. Date: Mar. 18, 2010

(54) ALERTS FOR AN ENTERPRISE APPLICATION SYSTEM

(75) Inventors: Anadi UPADHYAYA, Hyderabad (IN); Mitul Bhammar, Hyderabad (IN); Debasish Deb, Hyderabad (IN); Ty Hayden, Grand Junction, CO (US); Robert Watson, Danville, CA (US)

Correspondence Address: Squire, Sanders & Dempsey L.L.P.;Oracle International Corporation, 8000 Towers Crescent Drive, 14th Floor, Vienna, VA, 22182, US

(73) Assignee: Oracle International Corporation, Redwood Shores, CA (US)

(21) Appl. No.: 12/209,747

(22) Filed: Sep. 12, 2008

(51) Int. Cl. G06Q 10/00

(52) U.S. Cl. 70/8; 705/7

(57) ABSTRACT

Systems and methods are provided that for enable alerts in an enterprise application system (EAS). An alert system receives a request to enable an alert definition for triggering an alert regarding human resources data in the EAS, monitors human resources data entered into the EAS by a manager via a user interface (“UI”), receives data that triggers the alert, and renders the alert in the UI.

### FIELD OF THE INVENTION

One embodiment is directed generally to Enterprise Application Systems (“EASs”), and in particular to alerts for an EAS.

### BACKGROUND INFORMATION

Enterprise Application Systems are typically integrated software applications that perform business functions such as accounting, production scheduling, customer information management, human capital management, etc. They are frequently implemented on servers and simultaneously provide services to a large number of users, typically over a computer network. These systems are in contrast to the more common single-user software applications which run on a user's own local computer and serve only one user at a time. Typically, the Enterprise Application System (“EAS”) is implemented as a group of software modules sharing a common database. Examples of an EAS include a Customer Relations Management (“CRM”) system, a Manufacturing Resource Planning (“MRP”) system, and an Enterprise Resource Planning (“ERP”) system.

Enterprise Resource Planning is an industry term for integrated, multi-module application software packages that are designed to serve and support multiple business functions. An ERP system can include software for manufacturing, order entry, accounts receivable and payable, general ledger, purchasing, warehousing, transportation and human resources. Evolving out of the manufacturing industry, ERP implies the use of packaged software rather than proprietary software written by or for one customer. ERP modules may be able to interface with an organization's own software with varying degrees of effort, and, depending on the software, ERP modules may be alterable via the vendor's proprietary tools as well as proprietary or standard programming languages.

One module that enjoys widespread use is the human resources module. A human resources module in an ERP system typically contains information that would be useful to employees regarding their work environment. For example, the human resources module might have data regarding new promotions or performance evaluations of coworkers. Managers of employees may use the human resources module to allocate compensation to their employees. However, human resources data may change at any time, and a manager may not be aware of all the changes to employee data. A manager may end up unintentionally allocating compensation such as a bonus to a person who has been terminated from the company. Alternatively, an employee might be getting paid below their target salary range unbeknownst to the manager.

### SUMMARY OF THE INVENTION

One embodiment is a method for providing alerts in an enterprise application system (EAS). The method includes receiving a request to enable an alert definition for triggering an alert regarding human resources data in the EAS, monitoring human resources data entered into the EAS by a manager via a user interface (“UI”), receiving data that triggers the alert and rendering the alert in the UI.

### BRIEF DESCRIPTION OF THE DRAWINGS

FIG. 1 is a block diagram of a system that can implement an embodiment that provides alerts for an EAS such as an ERP system;

FIG. 2 is a block diagram of Human Resources module in accordance with an embodiment;

FIG. 3 illustrates an example quick alerts user interface (“UI”) of an alerts module in accordance with an embodiment;

FIG. 4 illustrates an example custom alerts UI of an alerts module in accordance with an embodiment;

FIG. 5 illustrates an example alerts configuration UI of an alerts module in accordance with an embodiment;

FIG. 6 illustrates an example human resources UI of human resources module in accordance with an embodiment;

FIG. 7 illustrates an example report by an alerts module in accordance with an embodiment; and

FIG. 8 illustrates method of providing alerts in a human resources module in accordance with an embodiment.

### DETAILED DESCRIPTION

An embodiment is directed to an alerts system that allows administrators of an EAS to define different kinds of alerts with varying severities. The alert has a named identifier along with a Boolean value that states whether that particular alert is enabled or disabled. Additionally, the alert has criteria that determines when the alert is triggered. In the criteria, the administrator can specify a value to compare with a particular processed data field or column. Alternatively, the administrator can specify the criteria as comparisons, e.g., “is greater than” or “contains,” between different processed data fields. The administrator can add as many fields in the criteria along with a flexibility to provide a Boolean operator which could be either ‘AND’ or ‘OR.’ The alerts may be customized by the administrator, or may be built into the alerts system and preconfigured. When a manager enters data into the EAS, such as compensation data on a compensation allocation page, they would see these alerts for each employee where the criteria specified for the alert matches that employee. The alerts would be evaluated against the actual data of the employee in real time, hence helping the manager to take a decision on compensation allocation. Entry or manipulation of the data may meet criteria for displaying an alert where previously an alert was not warranted. Such change would immediately inform the manager of that alert conditions are met. Additionally, the manager may view a summary report to see different kinds of alerts and employee counts, and further drill down into more information about the conditions that triggered the alert.

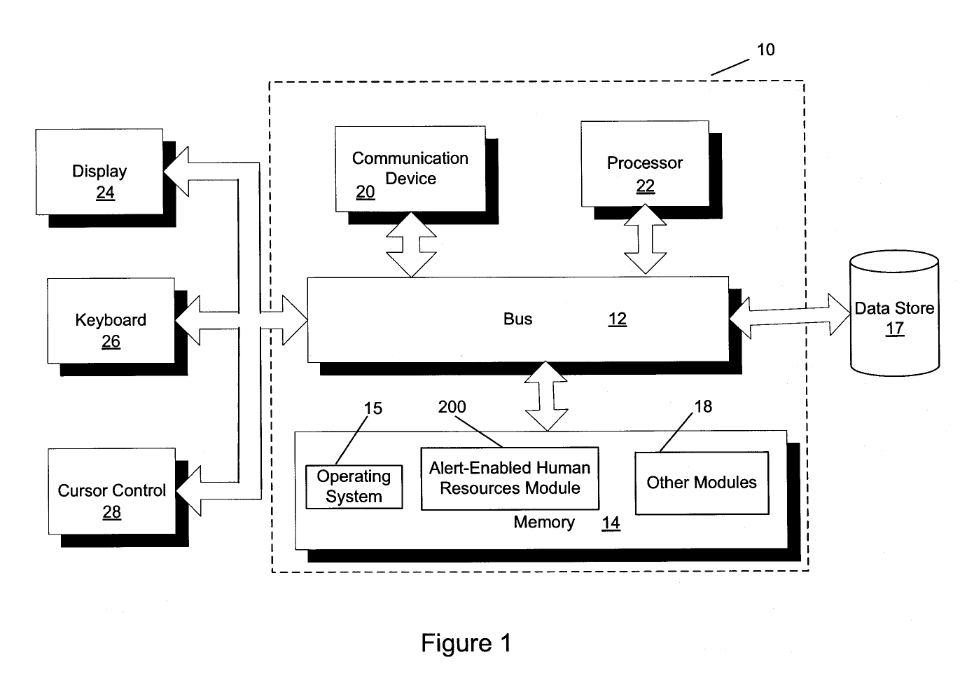

FIG. 1 is a block diagram of a system 10 that can implement an embodiment that provides alerts for an EAS such as an ERP system. System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network or any other method. System 10 may further include an external data store 17 for storing information, the data store 17 being commonly accessible to components of system 10 via bus 12.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”), for displaying information to a user. A keyboard 26 and a cursor control device 28, such as a computer mouse, is further coupled to bus 12 to enable a user to interface with system 10.

In one embodiment, memory 14 stores software modules that provide functionality when executed by processor 22. The modules include an operating system 15 that provides operating system functionality for system 10. The modules further include alert-enabled human resources module 200 that is described in greater detail below. In an embodiment, alert-enabled human resources module 200 is a module of an ERP system (not shown). Additional, fewer, and/or different modules 18, such as other ERP modules, may also be included in system 10.

ERP is a software architecture that facilitates the flow of information among the different functions within an enterprise. Similarly, ERP facilitates information sharing across organizational units and geographical locations. It enables decision-makers to have an enterprise-wide view of the information they need in a timely, reliable and consistent fashion. ERP provides the backbone for an enterprise-wide information system. At the core of this enterprise software is a central database that draws data from and feeds data into modular applications that operate on a common computing platform, thus standardizing business processes and data definitions into a unified environment. With an ERP system, data needs to be entered only once. The system provides consistency and visibility or transparency across the entire enterprise. A primary benefit of ERP is easier access to reliable, integrated information. A related benefit is the elimination of redundant data and the rationalization of processes, which result in substantial cost savings.

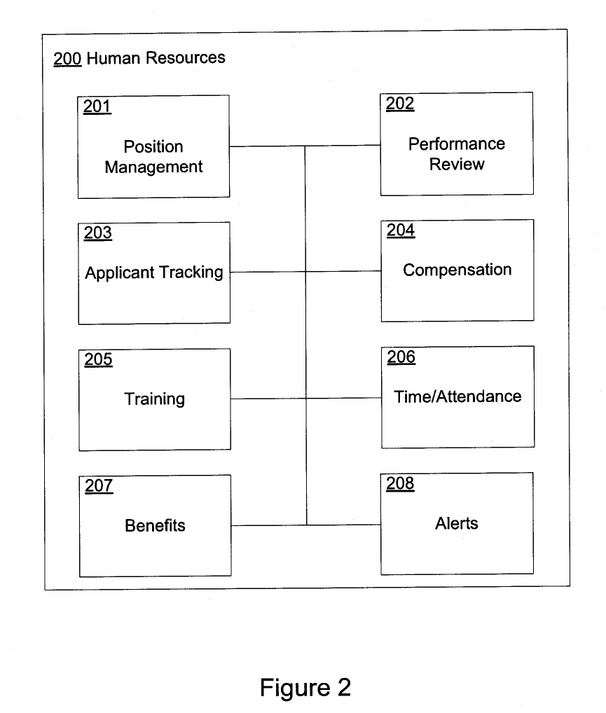

FIG. 2 is a block diagram of alert-enabled human resources module 200 in accordance with an embodiment. Alert-enabled human resources module 200 collects, utilizes and reports data relating to position management, performance review, applicant tracking, payroll, training, time and attendance, compensation and benefits, among other aspects. Alert-enabled human resources module 200 includes a plurality of modules 201-208 for specific purposes that collect, utilize and report data relating to human resources. Position management module 201 collects, utilizes and reports data relating to positions held by employees within the organization, and any change in those positions, among other aspects. Performance review module 202 collects, utilizes and reports data relating to performance evaluations of employees within an organization, for example, as the evaluations relate to promotion or compensation, among other aspects. Applicant tracking module 203 collects, utilizes and reports data relating to potential candidates for employment within the organization, among other aspects. Compensation module 204 collects, utilizes and reports data relating to employee compensation within the organization including salary, salary changes, payroll, bonus distributions, and stock options, among other aspects. Training module 205 collects, utilizes and reports data relating to continuing education courses available to employees, and which employees have completed such courses, among other aspects. Time and attendance module 206 collects, utilizes and reports data relating to hours worked, days present, sick leave, and vacation leave for employees within the organization, among other aspects. Benefits module 207 collects, utilizes and reports data relating to employee benefits, for example, health and dental insurance, transit benefits, pension and retirement programs, and profit sharing programs, among other aspects. Alert-enabled human resources module 200 further includes an alerts module 208 for configuring alerts that inform a manager that they have submitted invalid data to alert-enabled human resources module 200 via a user interface. In an embodiment, this user interface may be web-based.

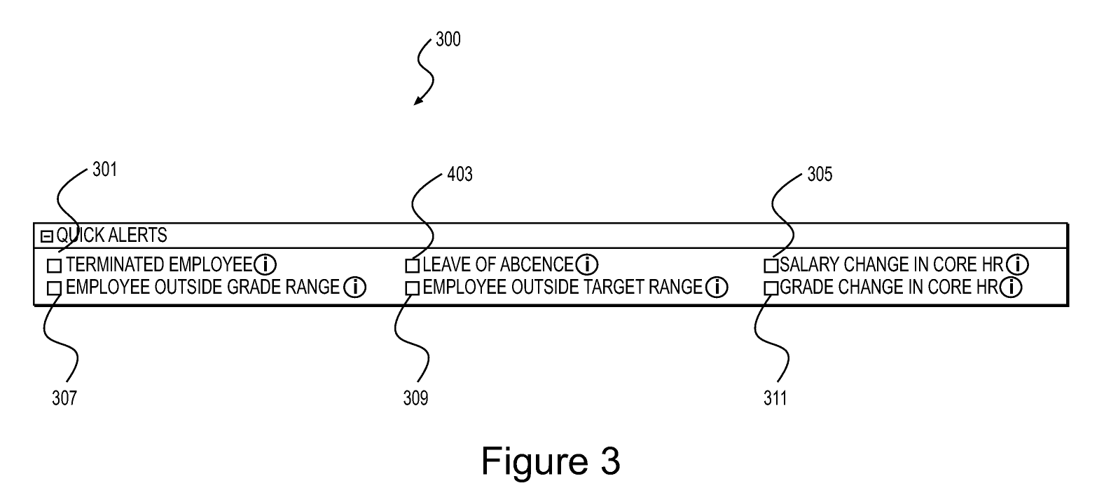

FIG. 3 illustrates an example quick alerts user interface (“UI”) 300 of alerts module 208 in accordance with an embodiment. An administrator may use the quick alerts UI 300 to enable preconfigured alerts that may be commonly advantageous to managers entering human resources data. Terminated employee checkbox 301, when selected, will enable an alert that informs the manager an employee has been terminated. Leave of absence checkbox 303, when selected, will enable an alert that informs the manager that the employee is on a leave of absence. Salary change in core HR checkbox 305, when selected, will enable an alert that informs the manager that an employee's salary has recently changed in the alert-enabled human resources module 200. Employee outside grade range checkbox 307, when selected, will enable an alert that informs the manager that an employee's salary is outside (above or below) their pay grade range. Employee outside target range checkbox 309, when selected, will enable an alert that informs the manager that an employee's salary is outside the target salary range. Grade change in core HR checkbox 311, when selected, will enable an alert that informs the manager that an employee's pay grade has recently changed in the alert-enabled human resources module 200.

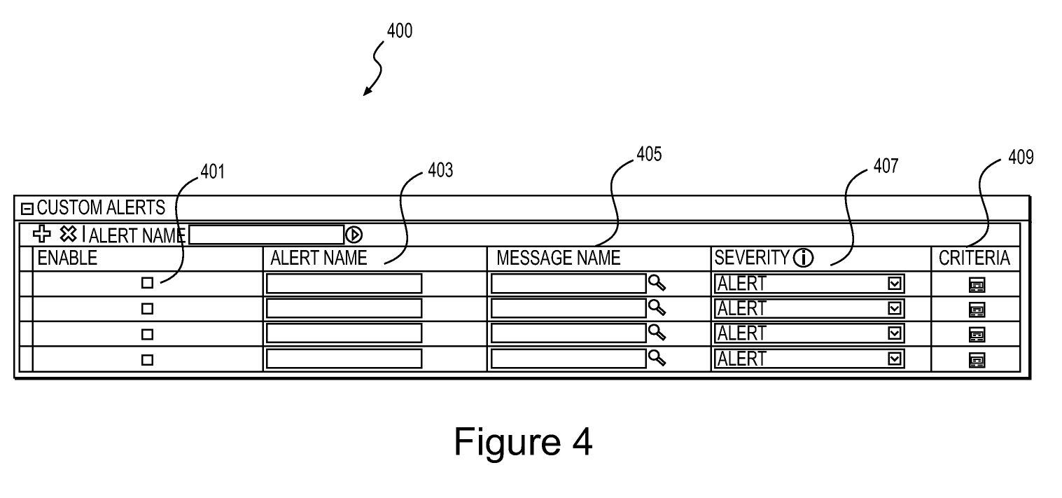

FIG. 4 illustrates an example custom alerts user interface (“UI”) 400 of alerts module 208 in accordance with an embodiment. Custom alerts are presented in a tabular format in custom alerts UI 400. An enable column 401 allows an administrator to check a box to enable an alert. An alert name column 403 allows an administrator to name the alert. A message name column 405 allows an administrator to compose a message that is displayed when the alert is triggered. A severity column 407 allows the administrator to select the severity of the alert from a drop down menu. For example, the alert might simply draw attention to a situation (“Alert”), provide additional information about an entry (“Information”), warn the administrator of a possibly invalid entry (“Warning”), or inform the administrator of an invalid entry (“Error”). For example, an “Error” alert may prevent submission of the data change altogether, whereas less critical entries may simple warn the manager when saving the changes. To define the criteria for triggering the alert, the administrator clicks on the criteria icon 409.

For example, the following table describes user-defined alerts, their triggering conditions, and the severity of the alert:

| Alert Message | Triggering Criteria | Severity |
|---|---|---|
| &EMPLOYEE_NAME is a new | Hire Date IS GREATER OR | Information |
| employee. | EQUAL TO 01-May-2007. | |
| (Ex: Joe Smith is a new employee) | | |
| Salary is outside pay grade range. | Proposed Allocation Amount IS | Alert |
| | LESS THAN minimum range | |
| | amount OR IS GREATER THAN | |
| | maximum range amount | |
| Salary Raise is more than 10% | Proposed Salary Adjustment | Warning |
| | Percentage IS GREATER THAN | |
| | 10 | |
| &EMPLOYEE_NAME did not | Previous Bonus Amount EQUALS | Information |
| receive a bonus last quarter. | 0. | |
| (Ex: Joe Smith did not receive a | | |
| bonus last quarter) | | |
| &EMPLOYEE_NAME has been | Termination Date IS NOT NULL | Error |
| terminated effective &DATE. | | |
| (Ex: Joe Smith has been | | |
| terminated effective 01-May-2007) | | |
| &EMPLOYEE_NAME is a key | Performance Rating EQUALS | Information |
| player in the Sales Department | “Outstanding” OR Ranking | |
| (That is rating is outstanding or | Percentile IS GREATER OR | |
| ranking is in top 5%, and employee | EQUAL TO 95 and Job EQUALS | |
| has job name of ‘Sales’) | ‘Sales’. | |
| Bonus Amount Given to | Bonus Amount IS GREATER | Error |
| &EMPLOYEE_NAME is above the | THAN Target Amount | |
| company recommendations. | | |
| (Similar Alert is also possible for | | |
| below company recommendations) | | |

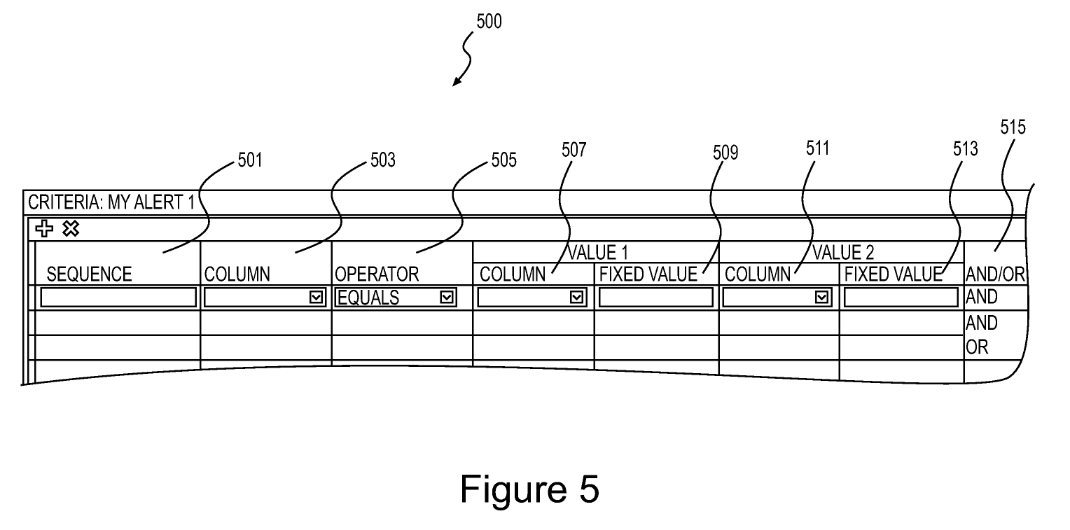

FIG. 5 illustrates an example alerts configuration user interface (“UI”) 500 of alerts module 208 in accordance with an embodiment. When an administrator clicks on the criteria icon 409, alerts configuration UI 500 opens to allow the administrator to define Boolean sequences for defining alert triggers. Alerts configuration UI 500 includes table column 501 for naming the Boolean sequence, table column 503 for selecting the first operand of the sequence in the form of a human resources data type using a drop down menu, table column 505 for selecting a Boolean operator using a drop down menu, table columns 507 and 509 for selecting a second operand data type and value, respectively, for comparison to the first operand. The administrator may add additional values for comparison using table columns 511 and 513, like table columns 507 and 509. Additional rows of Boolean sequences may be added to the first sequence using the AND/OR Boolean operators in table column 515. By way of example, an alert may be configured where table column 503 is selected as a “Last Appraisal” type, table column 505 is selected as a “Less Than” operator, table column 507 is selected as a “Last Appraisal” type, and table column 509 is fixed at a value of 3 (from a range of 1-5). This alert will be triggered for an employee whose last appraisal earned a value of less than 3. Such information may be valuable in determining whether a bonus is merited.

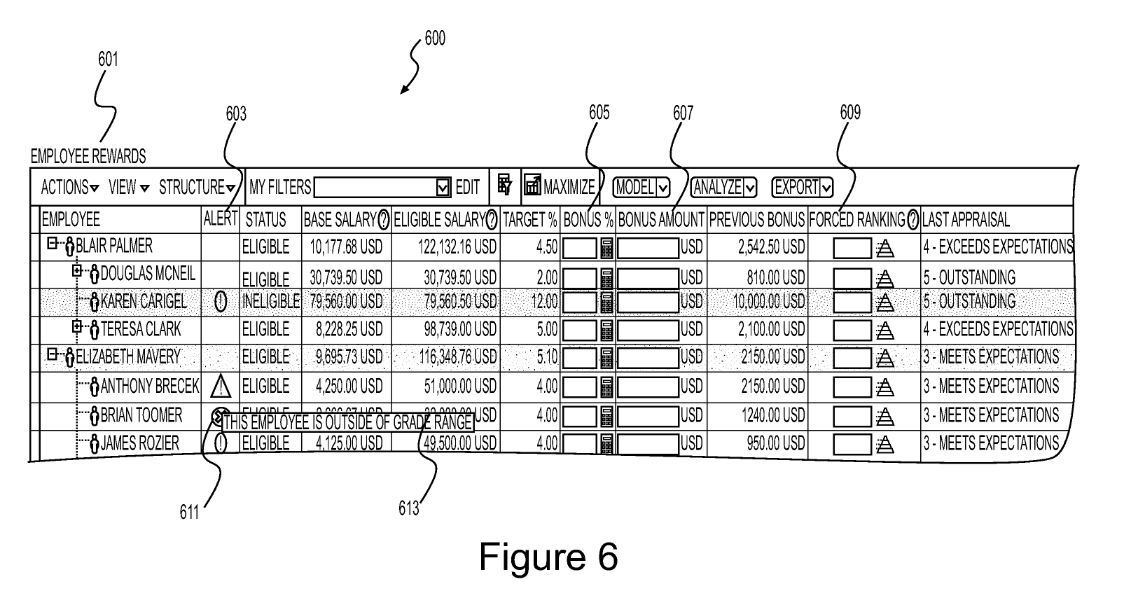

FIG. 6 illustrates an example human resources user interface 600 (“UI”) of alert-enabled human resources module 200 in accordance with an embodiment. Human resources UI 600 is an example of how a manager might enter data into alert-enabled human resources module 200. In this example, the data is compensation data. Human resources UI 600 includes employee rewards table 601 having several columns describing compensation statistics, such as the employee name, compensation status, base salary, eligible salary, percentage difference from a target salary, amount of previous bonus, and result of last appraisal. Employee rewards table 601 in particular includes an alert column 603 in which alert symbol may be rendered when triggered. Employee rewards table 601 further includes bonus percent column 605 and bonus amount column 607 that allow a manager to enter a bonus for an employee either by percentage of salary or as a discrete dollar amount. Employee rewards table 601 further includes forced ranking column 609 that allows a manager to give the employee a ranking. For example, the manager might be required to rank their employees in order of productivity. Bonus percent column 605, bonus amount column 607, and forced ranking column 609 illustrate examples of where a manager may input human resources data into alert-enabled human resources module 200. Alerts module 208 monitors the input of this data, and when the data satisfies a rule definition for triggering an alert, alerts module 208 renders an alert in real-time in the alert column 603 of employee rewards table 601 in human resources UI 600. For example, a manager might try to give employee “Brian Toomer” a bonus that exceeds his pay grade range. In this case, an alert 611 is rendered in alerts column 603 and an alert message 613 is displayed.

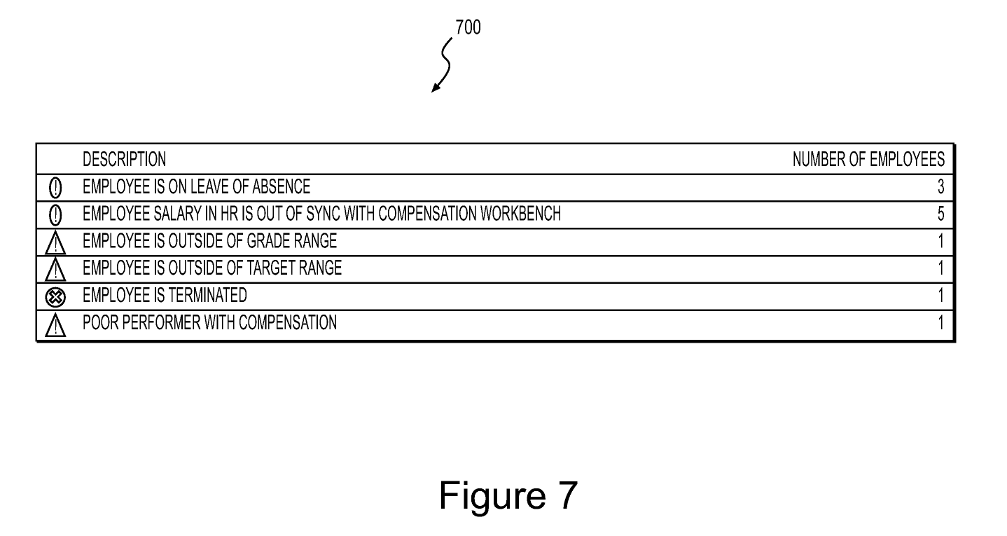

In addition to rendering alerts in a user interface in real-time, alerts module 208 may also generate a report of alerts for human resources data. FIG. 7 illustrates an example report 700 by alerts module 208 in accordance with an embodiment. The example report 700 shows that 3 employees on leave of absence, 5 employees are receiving a salary out of synch with a compensation workbench, 1 employee is outside their pay grade range, 1 employee is outside their target pay range, 1 critical alert that an employee has been terminated, and 1 alert that an employee is receiving compensation despite poor performance.

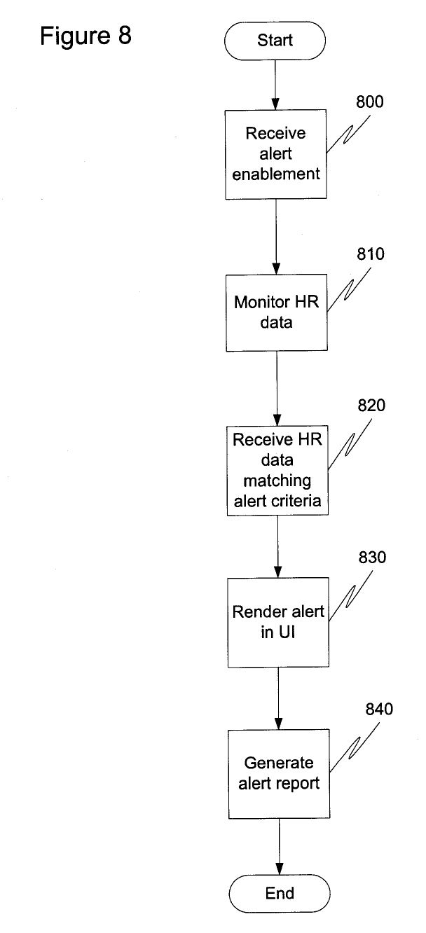

FIG. 8 illustrates a flow diagram of the functionality of alerts module 208 in accordance with an embodiment. In one embodiment, the functionality of the flow diagram of FIG. 8 is implemented by software stored in memory and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software. First, an administrator enables an alert via alerts module 208 (800). The alert may be a quick alert or a custom alert, as previously described. For purpose of example and illustration, assume the administrator enables the “Terminated Employee” alert that informs a manager that an employee is receiving compensation after termination. Alerts module 208 then begins monitoring human resources data entered by managers (810). Later, a manager attempts to enter data that satisfies alert criteria into alert-enabled human resources module 200 (820). For example, the manager tries to give a bonus to an employee who has been terminated. Alerts module 208 then renders in a human resources UI, in real-time as the manager enters the data, an alert informing the manager that the data they have entered is invalid and displaying an error message telling the manager why the data is invalid (830). Periodically, alerts module 208 may provide a report of human resources data that has triggered alerts (840).

Thus, in an embodiment managers may allocate compensation despite having limited knowledge of changes in employee profiles. Instead of logging into other modules to look up personnel data, an alerts system automatically informs them when they have entered data that is invalid or may be invalid. Thus, the alerts system reduces time required to allocate compensation, allows allocations to be based on important facts, and allows fast decision making to avoid inequality in compensation distribution.

Some embodiments of the invention have been described as computer-implemented processes. It is important to note, however, that those skilled in the art will appreciate that the mechanisms of the invention are capable of being distributed as a program product in a variety of forms. The foregoing description of example embodiments is provided for the purpose of illustrating the principles of the invention, and not in limitation thereof, since the scope of the invention is defined solely by the appended claims.

What is claimed is:

1. A method for providing alerts in an enterprise application system (EAS), comprising:
receiving a request to enable an alert definition for triggering an alert regarding human resources data in the EAS;
monitoring human resources data entered into the EAS by a manager via a user interface (“UI”) in real-time;
receiving data that triggers the alert; and
rendering the alert in the UI in real-time.

2. The method of claim 1, wherein the alert definition is a custom alert definition provided by an administrator.

3. The method of claim 1, wherein the alert definition is a Boolean sequence of human resources data.

4. The method of claim 1, further comprising generating a report of at least one triggered alert.

5. The method of claim 1, wherein the human resources data is employee compensation data.

6. The method of claim 5, wherein the alert definition, when satisfied, triggers an alert to inform the manager that an employee is one of terminated, on a leave of absence, outside pay grade range, and outside target range.

7. The method of claim 5, wherein the alert definition, when satisfied, triggers an alert to inform the manager that an employee has one of changed salaries and changed pay grades.

8. The method of claim 1, wherein the alert is preconfigured.

9. The method of claim 1, wherein the EAS is an enterprise resource planning (ERP) system.

10. The method of claim 1, wherein rendering the alert in the UI further includes preventing entry of invalid data in the UI.

11. A computer-readable medium having instructions stored thereon that, when executed by a processor, cause the processor to provide alerts in an enterprise application system (EAS) and that comprises:
receiving a request to enable an alert definition for triggering an alert regarding human resources data in the EAS;
monitoring human resources data entered into the EAS by a manager via a user interface (“UI”);
preventing entry of data that triggers the alert; and
rendering the alert in the UI.

12. The computer-readable medium of claim 11, wherein the human resources data is employee compensation data.

13. The computer-readable medium of claim 12, wherein the alert definition, when satisfied, triggers an alert to inform the manager that an employee is one of terminated, on a leave of absence, outside pay grade range, and outside target range.

14. The computer-readable medium of claim 11, wherein the EAS is an enterprise resource planning (ERP) system.

15. The computer-readable medium of claim 11, wherein the monitoring occurs in real-time.

16. A system for providing alerts in an enterprise application system (EAS), comprising:
means for receiving a request to enable an alert definition for triggering an alert regarding human resources data in the EAS;
means for monitoring human resources data entered into the EAS by a manager via a user interface (“UI”);
means for receiving data that triggers the alert; and
means for rendering the alert in the UI.

17. The system of claim 16, wherein the EAS is an enterprise resource planning (ERP) system.

18. The system of claim 16, wherein the monitoring occurs in real-time.

19. A system for providing alerts in an enterprise application system (EAS), comprising:
a user interface having at least one first field for entering compensation data for an employee and a second field for displaying an alert about the compensation data for the employee; and
an alerts module that monitors the entered compensation data for the employee in real-time and renders the alert in the second field in real-time when the entered compensation data for the employee is invalid.

20. The system of claim 19, wherein the EAS is an enterprise resource planning (ERP) system.
